(19) United States
(12) Patent Application Publication
(10) Pub. No.: US 2008/0186381 A1
(43) Pub. Date: Aug. 7, 2008

(54) CUSTOMER SERVICE COUNTER/CHECKPOINT REGISTRATION SYSTEM WITH VIDEO/IMAGE CAPTURING, INDEXING, RETRIEVING AND BLACK LIST MATCHING FUNCTION

(75) Inventors: Chun Biao GUO, Singapore (SG); Ruowei ZHOU, Singapore (SG); Qi TIAN, Singapore (SG)

Correspondence Address: GREENBLUM & BERNSTEIN, P.L.C., 1950 ROLAND CLARKE PLACE, RESTON, VA, 20191, US

(73) Assignees: VISLOG TECHNOLOGY PTE LTD., Singapore (SG); AGENCY FOR SCIENCE, TECHNOLOGY AND RESEARCH, Singapore (SG)

(21) Appl. No.: 12/028,432

(22) Filed: Feb. 8, 2008

Related U.S. Application Data
(63) Continuation of application No. 10/488,928, filed on Mar. 12, 2004.

(51) Int. Cl. H04N 7/18

(52) U.S. Cl. 348/143; 348/E07.085

(57) ABSTRACT

A system for capturing images of a person at a checkpoint including at least one image capture means for recording images of the person, a processing means to select a still image of the person from the recorded images, a control means for adding data to the still image and storage means for storing the still image and the data.

This application is a continuation of pending U.S. patent application Ser. No. 10/488,928, filed Mar. 12, 2004, which is a National Stage of International Application No. PCT/SG01/00187, filed Sep. 14, 2001, the contents of which are expressly incorporated by reference herein in their entireties.

### FIELD OF THE INVENTION

This invention relates to an image capturing and retrieval system, and in particular a system for capturing images of persons at a check point, analysing those images, and archiving for later retrieval.

### BACKGROUND OF THE INVENTION

In some circumstances it would be very useful to be able to capture the images of persons at a checkpoint to assist in identifying those persons. For example, it would be useful to be able to capture the images of people who are checking in for an airline, registering at the counter of immigration or processing large money withdrawals at a bank. Such images could be used to help identify the real identity of the person, no matter what name was used for registering.

Current attempts to provide such an image identification system are either CCTV or the normal digital record system which simply records a stream of images without indexing. Video cameras and other devices per se have been used previously in an attempt to improve security.

For example U.S. Pat. No. 4,370,675, U.S. Pat. No. 5,428,388, U.S. Pat. No. 5,923,363 and U.S. Pat. No. 5,032,820, proposed a sensor trigger system for video security systems. The video camera and microphone were triggered by means of a sensor (for example a doorbell). The video signal and voice could be sent to a remote monitor center. The key to the patent is that the power of the camera, microphone and monitor could be controlled by the sensor.

Other digital video processing related patents include U.S. Pat. No. 6,130,707 which proposed a region based difference detection system for the digitized video signal by comparing the image pixels in the adjacent frames. U.S. Pat. No. 5,850,470 proposed a neural network based deformable object locating and recognizing method. The system extracted identifying (face) features such as eye, eyebrow and nose and matched the features in the entire frame to locate the position of a face. U.S. Pat. No. 5,715,325 proposed a method to detect a face in a video image by identifying a top bottom and sides of a possible head region in a defined bounding box. Once a face candidate box is detected further verification was performed by verifying the eye location.

U.S. Pat. No. 5,703,655 disclosed a system and method for retrieving segments of stored video programs using closed caption text data. The closed text data was extracted from video programming signals received. The text record based on the extracted closed caption data could be generated. U.S. Pat. No. 5,819,286 proposed a video indexing and query execution system by identifying each symbol or icon. The query specifies the criteria which the data of the database is to be identified. U.S. Pat. No. 5,164,865 disclosed a system in which an operator manually indexes each video clip with text information. U.S. Pat. No. 5,136,655 proposed an automatic indexing system for speech and video clips. The audio information was inputted to a speech recognizer that recognized the spoken words. The video was inputted to a pattern recognizer that was capable of detecting scene changes. The word and scene data was recorded as an index to the accompanying audio and video presentation. U.S. Pat. No. 6,118,923 proposed a system that was able to do video indexing and retrieving. The video indexing was worked on televised programs based on story lines, story characters and the like programs. U.S. Pat. No. 6,137,544 proposed a system that was capable of doing video indexing by detecting significant scene differences such as video cuts from one scene to another based on DCT coefficients and macroblocks. A key frame filtering process filtered out less desired frames.

U.S. Pat. No. 5,237,408 proposed a sensor controllable system that was able to digitize and display the video data and sound an alarm when an alarm condition happened. This patent required a sensor to detect alarm situations. It could not analyse what really happened. U.S. Pat. No. 5,099,322 and U.S. Pat. No. 5,654,772 proposed an invention that could detect scene changes through frame-by-frame difference analysis in the segmented blocks, although in many scenarios, change detection was not accurate. For example when the illumination of the scene changes.

### OBJECT OF THE INVENTION

It is an object of this invention to provide an improved system which allows for the images of the person to be captured, analysed and stored in a database for later retrieval. Ideally, the system would determine which image was to be archived, and would also be able to cross check the captured image with other stored images.

### SUMMARY OF THE INVENTION

With the above objects in mind the present invention provides a system for capturing images of a person at a checkpoint including:

at least one image capture means for recording images of the person;

a processing means to select a still image of said person from the recorded images;

a control means for adding data to the still image; and

a storage means for storing the still image and data.

Ideally the processing means will be able to select the clearest image of the face of the person. This may be achieved through the use of video analysis, moving object detection and matching, motion detector analysis and other image processing techniques.

The present invention may be particularly suited to airline check-in counters were the image of each person checking in may be captured and stored for later reference.

The control means will ideally be able to add identifying information relevant to the captured image. For an airport this could include data such as the airline, flight number, customer name, and arrival time. The control means may also enable manual information to also be added, such as information added via a computer by a checkpoint operator.

The storage means may be adapted for short and/or long term storage depending on the implementation.

In the preferred embodiment, the system will further compare the still image with stored images. The stored images may be used as security or validation. In terms of security, if the still image matches a stored image of a person “black listed” an alert may be sounded. Again for an airport scenario the “black list” may include persons who present a security or safety risk to the airline. If the system does detect such a person appropriate actions may be undertaken.

### BRIEF DESCRIPTION OF THE DRAWINGS

FIG. 1 shows the hardware structure of the preferred embodiment of the customer service counter/check point registration system.

FIG. 2 shows the software structure of information registration and key frame capturing for the preferred embodiment of the customer service counter/check point registration system.

FIG. 3 shows the software structure of information retrieving for the preferred embodiment of the customer service counter/check point registration system.

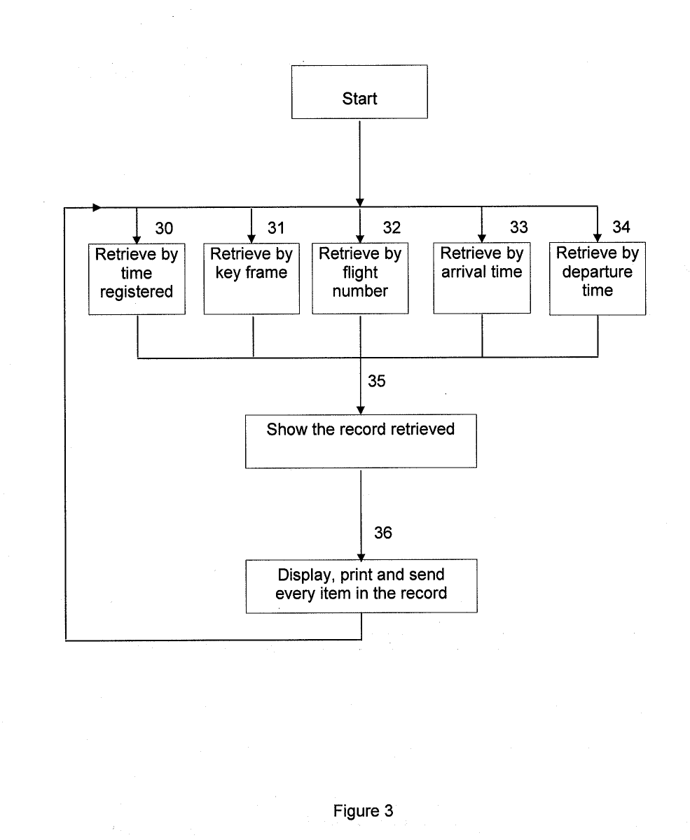

### DETAILED DESCRIPTION OF THE PREFERRED EMBODIMENT

The preferred embodiment of the present invention will be discussed herein after in detail with reference to the accompanying drawings. Description of specific scenarios are provided only as examples. Consequently, the present invention is not intended to be limited to the embodiments shown, but is to be accorded the widest scope consistent with the principles and features disclosed herein.

In many check point registration and service counter scenarios, it is desired to capture the current picture of the people who are registering. When an unexpected thing happens, the picture of all the people can be retrieved quickly and correctly. For example at the check-in counter of an airport, the current picture can be captured, then should any unexpected thing happen to an airplane such as kidnapping or any other disaster, the current image of all the passengers on the airplane can be retrieved and reviewed. In addition the system could extract features from the clearest face image and match the feature with the features extracted from stored face images that are kept in a “black list”. Once a match occurs, the system could sound an alarm to inform the police or immigration officer or whoever requires the information.

The system could retrieve all the pictures of the passengers on the airplane. The system can also send the retrieved information through the Internet to anywhere immediately. It is not only useful in identifying the passengers, but also can help police to verify the criminal. The clearest face can be used in face verification from a “black list”. It can be used at immigration checkpoint for preventing a culprit from going through the checkpoint.

The customer service counter/check point registration system can capture the video/image from the life event automatically. The captured video/image will be indexed with other information such as video clips or clearest face images. In the airport check in counter scenario, the video/image can be indexed with clearest face images, flight number and time information. During the registration, the detected clearest face will be matched with a “black list” and sound an alarm should a match happen. In the service counter of a bank scenario, the key frame detection can be triggered by motion detection. While the said motion detection is performed by a motion vector analysis based on the MPEG video clips. The captured video/image can be indexed with clearest face images during, the transaction processing time.

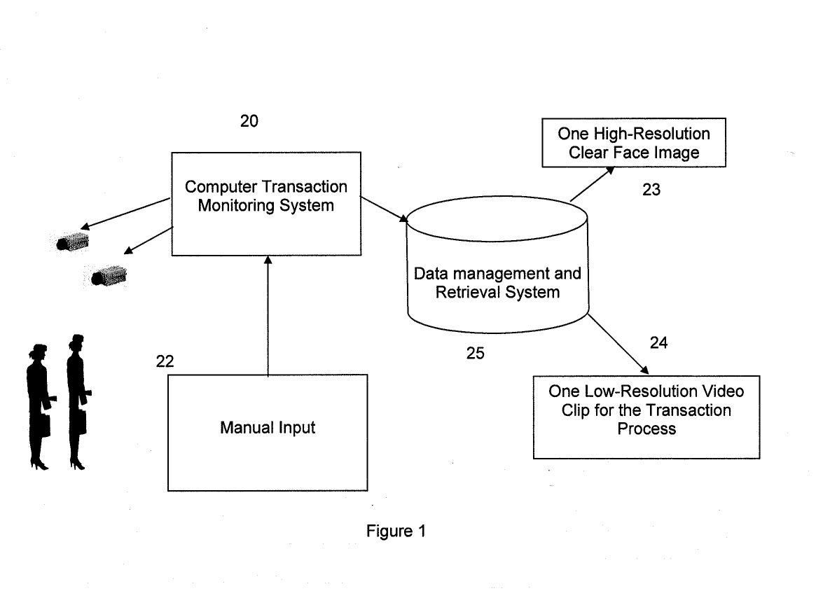

Referring now to FIG. 1 there can be seen the system hardware components and interconnection of the preferred embodiment. The system includes a processing means such as a desktop computer 20 with suitable video capturing capabilities, which can be connected to at least one camera 21. For simplicity, we will consider the example of a person 22 checking in or registering with an airline for a flight, although it will be understood that other checkpoints or counters are equally applicable.

As noted above it is desirable to capture the images of people 22 who are checking in for an airline, as this can help to identify the real identity of the people 22, no matter what name is used for checking in or registering. The image 23, registered name, time and other relative data (for example at an airport the data will likely be airline, flight number, departure time and landing time) will be saved and managed automatically. Outdated information can be deleted automatically, for example, considering an airport check in registration counter as an example then, if the airplane landed safely, the data could be deleted automatically. If some thing happened to the airplane then, all the data including the images could be retrieved immediately. Alternatively, the images may be retained for a period of time to allow later reference. This could then assist in tracking the movements of a person such as a suspected smuggler.

Once a registration is started, the system will read the passenger information from the registration terminal. It also analyses the video of the counter. For every video clip during the registration period, the clearest face will be selected to be the index of the video clips. In the database, the following group of information may be recorded:

Record ID

Registered time

Customer's name

Flight Number

Arrival time

Departure time

Clearest face image

Video clips

Related record ID

Not all these items may exist in some applications, and other items may be included dependent on the implementation.

Once the information needs to be retrieved, it can be retrieved by any of the information headings in the database, such as those listed above. For example, if a disaster happened on one airplane, the flight number would be the logical retrieving key word. Based on the flight number all of the information for every passenger can be retrieved. If we are interested in some passengers, we can continue to see the detail information of the customer. For example the clearest face images 23 and the video clips 24. The clearest face images can be displayed, printed and sent to anywhere through the Internet.

The record can also be retrieved by the related record ID. Some times, a passenger may not do the registration by themselves but rather will rely on a companion to do the registration. The passenger does not have the clearest face detected. But through the related record ID, the current clearest face image of his/her companions can be found. From the information of his/her companion we can obtain more information about the passenger.

From the above description, It can be seen that the system may be composed of two main software component, namely: information obtaining and information retrieving.

For information obtaining, the video analysis and clearest face image detecting is triggered by registration processing. Once registration processing is started, the system will start to analyse the video by using clearest face detecting to obtain the clearest face image for indexing the information registered. The clearest face may be determined by analyzing each frame of an image sequence to firstly locate the position of the face and then determining which face is the clearest face. To determine the clearest face, each face may be assigned a numerical value which is calculated based on predefined components such as recognisable features, and contrast values. The clearest face image 23 will be saved in the database 25 with other registered information. This scenario may happen at an airport check-in counter, immigration checking point, hotel counter, hospital registration counter, bank counter etc.

The video analysis and clearest face image detecting can also be triggered by a motion detection processor which is performed by analyzing the motion vector in a mpeg video stream.

The clearest face image obtaining procedure can also be triggered by motion detection analysis. The motion detection can be performed in the entire frame or in some selected regions. Once any motion object is detected, the clearest face image detection processing will be started.

During the registration procedure, the clearest face image can be sent to a recognize module. In the recognize module, the features extracted from the clearest face image will be matched with the features extracted from the images in a “black list”. Once there is a match, the system can sound an alarm signal immediately.

Automatic time stamps may be attached to the key frames and the video clips, so that the time stamp and the key frame can be used to retrieve the information.

The registered information may also be attached to the key frames and the video clips, and the registered information can also be used to retrieve the information.

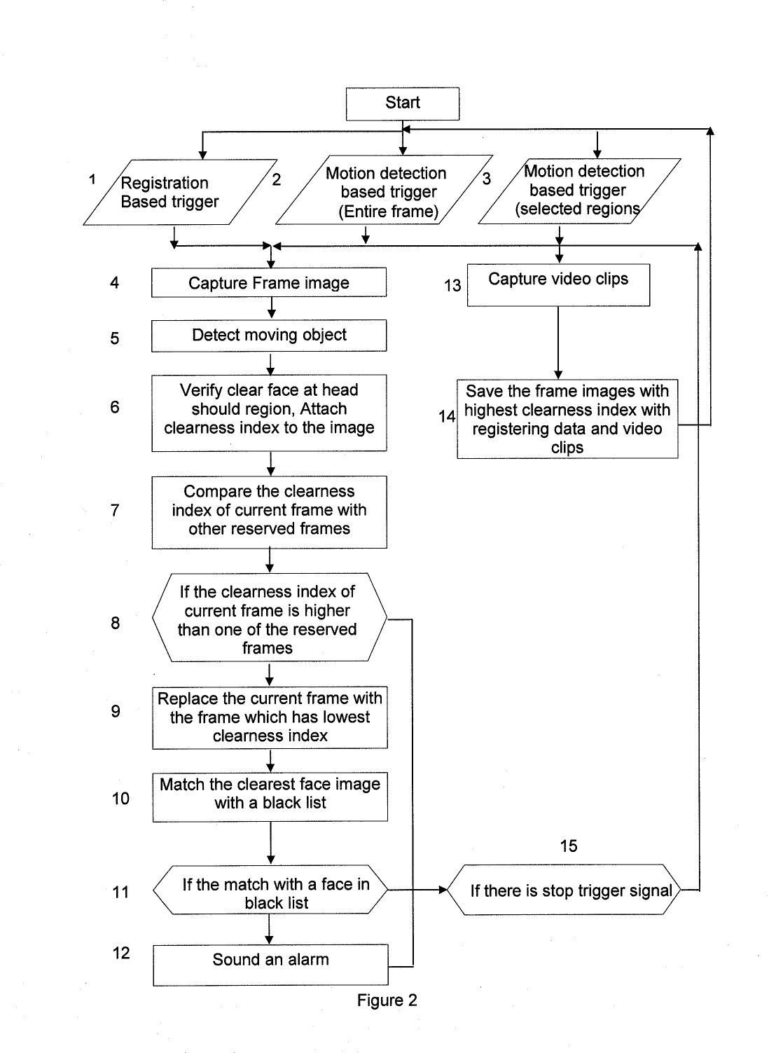

Referring now to FIG. 2, a possible software embodiment of the preferred invention can be seen. In order to capture images of persons at a checkpoint, for example checking in at an airline, the system may be triggered automatically, manually, or semi-automatically. The system may be configured such that an operator initiates the process. Alternatively, in an airline scenario the process may be initiated by commencing the registration process 1, such that when the check-in attendant begins the registration process of a passenger the system begins recording. Alternatively, the system may be initiated by motion detection, either through an entire frame 2, or through selected regions 3. This method may be particularly advantageous in a bank or gallery, in which a person need not necessarily approach a check-in counter.

Once the process is triggered, images of the person are captured for any suitable capture means such as a video camera. The images from the video camera may then be passed to a processing means which can detect any moving objects 5 within that frame. The processing means may also allow for the head and/or face of a viewer to be detected and extracted from the image.

Once the face or head of the person has been detected 5, the system will then analyse this image to determine its clarity 6. If this is the first image detected, the system will automatically assign this image or frame as being the clearest. If a previous frame has been detected and a clarity value assigned, then the system will compare the clarity value of the present frame with that of the stored frame 7. If the current frame presents a clearer image than that of the stored frame, then the system will replace the stored frame with the current frame 8, 9.

In the preferred embodiment, the system will compare the clearest face detected with that of faces stored on the system. These stored faces may include a “black list” 10 of persons who may pose some security or safety risk or be identified for any other reason. If the system detects a match between the current face and the “black list” 11, then an alarm or alert 12 may be sounded. The system may continue in this way by analysing each frame of a video whilst a person is being detected.

The system may also elect to capture an entire video clip 13 of the person. This video clip may be saved together with the highest clarity frame, and any other relevant data in the database. The relevant data may include details such as the passengers name, flight information and time of departure.

Once this information has been collated and stored, the system may then consider the next person or passenger.

For Information Retrieving and Management the system manages the data automatically. The duration of the data to be kept can be defined in a configuration file. The outdated data can be deleted automatically.

The data saved can be retrieved by any item in the record including:

Registered time stamp based retrieving 30;

Customer name based retrieving;

Key frame based retrieving 31;

Flight number based retrieving 32;

Arrival time based retrieving 32;

Departure time based retrieving 34; and

Clearest face image based retrieving, or any other item.

Once the record of the information is retrieved, any item in the record can be shown or displayed 35. The video clips can be played and replayed on the monitor of the system.

The retrieved record can be printed, or sent by e-mail 36.

The present invention concerns a system for efficiently archiving, indexing and retrieving images and video clips for application at a check-point counter for immigration, airports etc. The system analyses the video stream, key frame images are selected by different definitions dependent on the application scenario. The key frame image can be defined either by words or sample images. The key frame images and the video clips will be saved with other relative information. At an airport check-in counter, for example, the clearest face images are defined as key images. The clearest face images will be saved with the relative information, such as, registered name of the passenger, check in time, departure time, landing time, number of people accompanied, flight number, etc. If the airplane landed safely, all the data related with the airplane will be deleted or moved to a long term keeping region. If the airplane suffered a disaster or other problem, the airplane related information could be retrieved by flight number. All the face images on the airplane could be retrieved with each passenger's registered name. As a current face image carries real face information, it can help the authority concerned to identify the identity of every passenger on the airplane.

This invention relates to life event video saving, indexing and retrieving, It uses video processing and image processing technologies such as video analysis, moving object detection and matching, motion vector analysis, clearest face image capturing and verifying, image retrieve, video retrieve and face recognition and verification with a “black list”. The invention can be applied at checkpoints of an airport, immigration checkpoint counters and service counters at banks etc.

What is claim is:

1. A system for capturing images of a person at a checkpoint including:
at least one image capture means for recording images of said person;
a processing means to select a still image of said person from said recorded images;
a control means for adding data to said still image; and
a storage means for storing said still image and said data.

2. A system as claimed in claim 1 wherein said processing means selects the still image having the clearest image of the face of the person.

3. A system as claimed in claim 1 wherein said image capture means is activated by a trigger activated by an operator.

4. A system as claimed in claim 1, wherein said image capture means is activated by an automatic trigger.

5. A system as claimed in claim 4, wherein said automatic trigger is activated by motion detection.

6. A system as claimed in claim 1 wherein said image capture means includes a video camera.

7. A system as claimed in claim 1 wherein said control means may add data automatically and/or manually by an operator.

8. A system as claimed in claim 1, wherein video clips of the person are stored together with said still image and said data.

9. A system as claimed in claim 1 wherein said still image is compared to a set of stored images.

10. A system as claimed in claim 9 wherein an alert is signaled if said still image matches an image on the stored set.

11. A system as claimed in claim 1, further including a query means to enable a person to review and/or retrieve said stored images and said data.

12. a system as claimed in claim 11 wherein the retrieved image and data may be forwarded over a network.

13. A airline check-in counter including a system as claimed in claim 1.

14. A airline check-in counter as claimed in claim 13 wherein said data includes:
airline information,
flight number,
customer name, and
arrival time.
